(19) United States
(12) Patent Application Publication
(10) Pub. No.: US 2001/0006489 A1
(43) Pub. Date: Jul. 5, 2001

(54) System and method for rewarding a golfer for rapidly playing a round of golf

(76) Inventor: James T. Gaffney, Delmont, PA (US)

Correspondence Address: JAMES L. SHERMAN, 5860 DASHWOOD DRIVE, BETHEL PARK, PA, 15102, US

(21) Appl. No.: 09/753,269

(22) Filed: Dec. 29, 2000

Related U.S. Application Data
(63) Continuation-in-part of application No. 09/474,537, filed on Dec. 29, 1999.

(51) Int. Cl. G04B 47/00

(52) U.S. Cl. 368/10

(57) ABSTRACT

A system and method for rewarding a golfer for rapidly playing a round of golf at a golf course includes recording the times of the golfer for beginning and for ending the round of golf to establish a total time for playing the round of golf and includes the golfer being qualified to receive a reward if the total time for playing the round of golf is less than a predetermined desired play time as established by the management of the golf course. In the alternative, there is a system and method for rewarding the golfer for rapidly completing a round of golf at a golf course which includes recording the actual ending time differential for the golfer for competing the round of golf after the completion of the round of golf by a preceding golfer to allow the golfer to be alternatively qualified to receive the reward if the actual ending time differential is less than a predetermined desired round ending time differential as established by the management of the golf course.

This application is a continuation-in-part of pending application Ser. No. 09/474,537, filed on Dec. 29, 1999.

### BACKGROUND OF THE INVENTION

1. Field of the Invention

This invention relates to a system for rewarding a golfer for rapidly playing a round of golf at a golf course and, more specifically, to such a system which records the times for beginning and for ending the round of golf to establish a total time for playing the round of golf and which enables the golfer to receive a reward if the total time is less than a predetermined desired play time as established by the management of the golf course. The invention further includes a central data base to develop a playing history for each golfer using the system at a plurality of golf courses and to qualify each golfer for possible additional rewards. The invention still further includes a means for providing an alternative offering of the reward based on the golfer completing the round of golf within a predetermined round ending time differential after the completion of the round by a preceding golfer on the course.

2. Brief Description of the Prior Art

With the increasing popularity of golf, many courses, both public and private, are becoming more crowded. It is important for golfers to play a round of golf at reasonable speed, especially when the course is crowded, in order to allow other to enjoy the golf course. If only a few of the golfers on the course play relatively slowly, a resulting delay can affect numerous subsequent golfers on the course. Additionally, such slow play can significantly reduce the total number of golfers that can effectively use the golf course on a particular. As a result, the golf course might experience a direct loss of revenue which could be compounded if the course gains a reputation for slow play and more experienced golfers choose to select a different golf course at which a round of golf may be played at a more reasonable speed.

Consequently, the management at most golf courses has used various means in an attempt to eliminate slow play. It is not uncommon for a golf course employee to basically tour or monitor the course to observe the play of various group or players to detect slow play and attempt to have the guilty golfers to speed up their play. Using such employees is relatively expensive, requires tact and is not always that successful since many guilty golfers either do not consider themselves slow players or are not really concerned about the opinion of management. When the golf course management tries to enforce rules against slow play, the golfers playing slow may not appreciate the actions taken against them and the golfers for whom the conditions may be improved may not be aware of the efforts on their behalf. If the golf course management does not enforce the rules against slow play, the golfers unnecessarily delayed would tend to blame the course management. In either case, the golf course management seems to be in the middle and the efforts thereby to improve the playing conditions are seldom fully appreciated.

In order to eliminate the need to physically use golf course employees to directly monitor the players, any one of a number of devices that could be carried on the golf cart or golf bag by golfers could be employed at a golf course to allow the golfers to self monitor their progress during a round of golf.

U.S. Pat. No. 5,216,641 discloses an indicator device that can be configured for the particular course on which it is to be used to indicate which hole and where on that hole that the golfer should be if playing at an acceptable speed of play. The preferred embodiment assumes an overall playing time for the round of about four hours and appears to be difficult to adjust for a different overall playing time. U.S. Pat. No. 5,386,990 discloses a golf playing timer that includes means of adjusting the time to play each hole but again includes a fixed overall playing time, which in this case is five hours, and there is no indication that this overall playing time could be conveniently altered. U.S. Pat. No. 5,481,093 is directed to a similar device but appears to include means for selecting an overall playing time of either four or four and one half hours of playing time.

U.S. Pat. No. 5,523,985 discloses a golf course timer that is slightly more flexible since it can be adjusted by the golf course management prior to the playing of the round to one of seven specific times ranging from two and one half hours to four hours. U.S. Pat. No. 5,335,212 teaches golf timers that are significantly more sophisticated and complicated. The electronic timers mounted on all of the golf carts are programmed by golf course personal to establish the time to play each hole and the overall playing time. However, changes to the program would need to be made to each timer individually and would require detailed adjustment of each of the playing times or the use of a preprogrammed magnetic disk or chip for a more convenient means of changing all the play times at simultaneously.

To effectively use some of these devices as discussed above, the golf course would be required to make a significant investment to acquire a large number of such devices in order to provide them on each golfer or golf cart. Additionally, assuming such changes are possible, additional effort and attention would be required to change or adjust the desired playing time for each of these individual devices. In fact, with a possible fixed playing time or the likelihood that the preselected time not be appropriate once the round of golf is begun, one could easily question whether the devices might not be more problematic than effective for speeding up the overall play on the golf course. In any case, assuming the that such devices were properly set for a desired playing time, the overall effectiveness of such devices depends on the willingness of each golfer to properly respond to direct or indirect pressure from the course management or other golfers when there is a positive indication of slow play that might interfere with the enjoyment or pleasure of others on the course. It is clear that some golfers believe that no golfer on the course would have a valid reason to tell others how fast to play a round of golf. They believe that because all golfers pay the same fees for a round of golf. Each golfer should be allowed to play at a rate that he or she considers necessary to locate and “effectively” advance the ball.

U.S. Pat. No. 4,303,243 discloses a different timer system than those discussed above with some advantages but with some clear disadvantages. The timer system uses a series of timers with each one being located at the tee area of each hole. Each timer includes a rotating element that has a plurality of evenly spaced, numbered markings corresponding to the number of golf groups that would be expected to tee off each hour. The golfers would be able to examine the timer at the beginning of each hole to see if, according to the rotated position of their group markings, their particular group is “early”, “on time”, “late” or “very late”.

When the course is set up by management prior to the beginning of play, the timer on each subsequent hole of set back for the expected time required to play the preceding hole. Accordingly, if, for example, group “one” plays each hole in the expect time for the first five holes, the group would be able to see the number “one” marking located in the “on time” region of the timer at each of the first six tees. However, if group “one” played slowly on the sixth hole, the number “one” marking on the timer located on the seventh tee area would have advanced past the “on time” region and would be located in the “late” region. Consequently, for the golfers of group “one” to return to an “on time” condition during the round, the play on subsequent holes would need to be faster than usual to eventually arrive at one of the timers at one of the tee areas with the number “one” marker again aligned with the “on time” region. If, however, the rate of play is not increased, each subsequent timer will indicate the group “one” continues to be “late” or “very late” until the round is completed.

Such a system has the advantage of only requiring one timer for each tee area and, with proper planning, would appear to be physically configured to be capable of being changed to adjust the overall playing time by the separate, controlled adjustment of each timer. Unlike the timers discussed above, such changes or adjustments could not be accomplished in the club house area but would require an employee to directly go to each timer throughout the course. On the other hand, there appears to be no reasonable means for altering the system if less than eight groups are expected to begin playing each hour as often occurs during golf outings or league play when it is as important as ever to try and minimize slow play. Even when the system could be properly configured to discourage slow play, the system again tends to require self-monitoring and depends on the good will and cooperation of most of the golfers on the course to be effective.

U.S. Pat. No. 5,086,390 discloses a much more sophisticated system for monitoring the play of a group of golfers on the golf course. The system includes location transmitters located throughout the course such as at each tee area. The golf carts of each group of golfers would include an mobile transmitter/receiver to receive indication that the cart is near a particular one of the location transmitters and then transmit that information to a central transmitter-receiver and control system in the club house. Accordingly, each golf cart can be monitored for its relative positioning on the course and a transmission back to the golf cart can be used to give an indication to the golfers whether or not they are playing at an acceptable rate and what adjustments in play should be made if required. The overall system can be used by golf course management to record golf cart use, analyze overall course time of play and even record the history of a particular group as tangible proof of unacceptably slow play.

While such a system appears to be very flexible, the overall cost of acquiring and maintaining the system is very significant. Additionally, because the system is complicated with so many transmitters and receivers, there remains a concern regarding the continued effective operation of the system over a long period of time and under the extreme weather conditions that are experienced at many golf courses.

A number of other sophisticated and detailed systems; such a those disclosed in U.S. Pat. Nos. 4,910,677; 5,127,044; 5,283,733 and 5,319,548; are intended to receive, record and report a significant amount of data regarding the scoring of a number of golfers on a golf course. While these systems may be advantageous for recording and totaling golf scores, they disclose nothing that would tend to support or encourage more rapid play of the golfers during a round of golf.

Accordingly, there remains a need for any system which is simply and easy to provide and can be effectively used to encourage the rapid play of as many golfers as possible on a golf course. It is clear that such rapid play is advantageous to the effective operation of a golf course and would tend to add to the overall enjoyment of most of the golfers on the golf course.

### OBJECTS OF THE INVENTION

It is an object of the present invention to provide a system for rewarding a golfer for rapidly playing and/or completing a round of golf at a golf course by a golfer.

It is another object of the invention to provide such a system that utilizes identification means for each golfer to record a start time and an end time for the round of golf by the identified golfer in order to be able to calculate the overall time of play for comparison with a predetermined desired play time.

It is yet another object of the invention to provide such a system which will result in a reward being offered the any golfer who has a play time which is equal to or less than the predetermined desired playing time.

It is still another object of the invention to provide such a system in which the predetermined desire play time and the offer of a reward can be established and selectively changed by the management of the golf course in order to be able to more effectively encourage the golfers to play rapidly for the benefit of the golf course, for increasing the playing enjoyment of most of the golfers and for directly rewarding those golfers that play the course within the predetermined desired play time.

It is also an object of the invention to provide such a system that can be easily changed by the management of the golf course as playing conditions change, for example, because of weather, group outings, or league play, at any time during the day to most effectively encourage more golfers, under the existing circumstances, to use their best efforts to play the round of golf as efficiently and rapidly as possible.

It is a further object of the invention to provide such a system in which the playing history of all of the golfers in the system is recorded and available to the various golf courses using the system to assist the management of the golf course to determine what might be the best starting time of a particular golfer.

It is still a further object of the invention to provide such a system in which all of the golfers in the system would be eligible of additional possible rewards to encourage overall loyalty to the system and specific loyalty to those golf courses that use the system.

In an alternative embodiment it is another object of the invention to provide a system that utilizes identification means for each golfer to record a start time and an end time for the round of golf by each identified golfer including a particular golfer and a preceding golfer on the course when the particular golfer is playing a round which includes the sequential playing of each hole of the round following the preceding golfer playing a similar round of golf that includes the predetermined number of holes to result in the completion of the round of golf by the golfer after the completion of the round of golf by the preceding golfer in order to be able to calculate an actual ending time differential for the round of golf by the golfer for comparison with a predetermined desired round ending time differential.

It is yet another object of the invention to provide such a system which will result in a reward being offered the any golfer who has an actual ending time differential which is equal to or less than the predetermined desired round ending time differential.

These and other objects of the invention are provided by a preferred embodiment thereof that includes a system for rewarding a golfer for rapidly playing of a round of golf that includes a predetermined number of golf holes at a golf course. The system includes an identification means for identifying the golfer, a first recognition device located on the golf course prior to a first golf hole of the golf course for recognizing the identification means at the beginning of the round of golf by the golfer and a second recognition device located on the golf course after a last golf hole of the golf course for recognizing the identification means at the end of the round of golf by the golfer. A control circuit is operably connected to the first recognition device for recording a start time of the round of golf of the golfer when recognizing the identification means and to the second recognition device for recording an end time of the round of golf of the golfer when recognizing the identification means. The control circuit is for determining a total time of play for the round of golf by the golfer from the start time and the end time, for comparing the total time with a predetermined desired play time for playing of the round of golf, and for offering a reward to the golfer when the total time is equal to or less than the predetermined desired play time.

The control circuit of the system includes a feature for selectively changing the predetermined desired play time by management of the golf course, whereby the predetermined desired play time is capable of being established by the management according to expected playing conditions at the golf course prior to the round of golf by the golfer. Additionally, the feature for selectively changing the predetermined desired play time by the management can be used during the round of golf by the golfer to change the predetermined desired play time if there is a change of the expected playing conditions during the round of golf.

The control circuit can include a feature for selectively establishing the offering of the reward by the management of the golf course.

The system for rewarding the golfer, when the golf course is one of a plurality golf courses in the system with each of the plurality of golf courses for separately rewarding a plurality of the golfers at the plurality of golf courses, can further include a central data base, a feature for recording each round of golf and each offering of the reward for each golfer in the central data base to establish a playing history of each golfer using any of the plurality of golf courses and a feature for selectively obtaining from the central data base the playing history for any one of the golfers by the management of each of the plurality of golf courses, whereby the management of each of the plurality of golf courses can use the playing history of any one of the golfers to select an appropriate starting time for any one of the golfers.

The system for rewarding the golfer can further include a feature of using the central data base to selectively provide additional offerings of different rewards to selected ones of the golfers.

When the predetermined number of golf holes is nine holes, the first golf hole is hole number one, the last golf hole is hole number nine, the first recognition device is prior to hole number one and the second recognition device is after hole number nine.

When the predetermined number of golf holes is eighteen holes, the first golf hole is hole number one, the last golf hole is hole number eighteen, the first recognition device is prior to hole number one and the second recognition device is after hole number eighteen.

When the round of golf includes a golf round break between hole number nine and hole number ten, the system further includes a third recognition device located after hole number nine for recognizing the identification means at a beginning of the golf round break to cause the control circuit to record a break start time, a fourth recognition device located prior to hole number ten for recognizing the identification means at a completion of the golf round break to cause the control circuit to record a break end time, and the control circuit for determining the total time of play from the start time and the end time including a feature for subtracting a total break time established from the break start time and the break end time.

In the system for rewarding the golfer, the identification means can include an identification card having a readable strip area including unique information to identify the golfer; the control circuit can include a course computer having timing component, a programming function, a storage feature and a display screen. The first recognition device and the second recognition device respectively include a first terminal and a second terminal operably connected to the course computer and the timing component thereof. Each of the first terminal and the second terminal also includes a component for scanning the readable strip area of the identification card to collect the unique information for the course computer and to establish the start time and the end time.

The system for rewarding the golfer can include at least the second terminal including a display screen for displaying at least the offer of the reward for the golfer when the total time of play is equal to or less than the predetermined desired play time.

In another preferred embodiment of the invention there is provided a system for rewarding a golfer for rapidly playing of a round of golf that includes playing a predetermined number of golf holes at a golf course. The system can include an identification card having a readable strip area including unique information to identify the golfer, a first terminal located on the golf course prior to the first golf hole of the golf course for scanning the readable strip area of the identification card to identify the unique information at the beginning of the round of golf by the golfer and a second terminal located on the golf course after the last golf hole of the golf course for scanning the readable strip area of the identification card to identify the unique information at the end of the round of golf by the golfer. The course computer has a programming feature, a timing component, a storage component and a display screen and is operably connected to the first terminal for recording a start time of the round of golf by the golfer when scanning the readable strip area and to the second terminal for recording an end time of the round of golf by the golfer when scanning the readable strip area. The course computer is for determining a total time of play for the round of golf by the golfer from the start time and the end time, for comparing the total time with a predetermined desired play time for the playing of the round of golf, and for offering a reward to the golfer when the total time is equal to or less than the predetermined desired play time.

In the system for rewarding the golfer, the second terminal can include a display screen for displaying at least the offer of the reward for the golfer when the total time of play is less than the predetermined desired play time.

The course computer can include a feature for selectively changing the predetermined desired play time by management of the golf course, whereby the predetermined desired play time is capable of being established by the management according to expected playing conditions at the golf course prior to the round of golf by the golfer and the predetermined desired play time is capable of being changed by the management during the round of golf by the golfer if there is a change of the expected playing conditions during the round of golf.

The course computer can include a feature for selectively establishing the offering of the reward by the management of the golf course.

The system for rewarding the golfer, when the golf course is one of a plurality of golf courses in the system with each of the plurality of golf courses for separately rewarding a plurality of the golfers at the plurality of golf courses, can further include a central data base, a feature for recording each round of golf and each offering of the reward for each golfer in the central data base to establish a playing history of each of the plurality of the golfers using any of the plurality of golf courses and a feature for selectively obtaining from the central data base the playing history for any one of the golfers by the management of each of the plurality of golf courses, whereby the management of each of the plurality of golf courses can use the playing history of any one of the golfers to select an appropriate starting time for any one of the golfers.

The system for rewarding the golfer can further include a feature of selectively providing additional offerings of different rewards to selected ones of the golfers from the central data base.

In yet another preferred embodiment of the invention, there is provided a method of rewarding a golfer for rapidly playing of a round of golf that includes playing a predetermined number of golf holes at a golf course. The method includes the steps of:

providing a readable device for identifying the golfer;

initially reading the readable device on the golf course at the beginning of the round of golf by the golfer;

recording a start time of the round of golf by the golfer during the initial reading;

subsequently reading the readable device on the golf course at the end of the round of golf by the golfer;

recording an end time of the round of golf during the subsequent reading;

calculating a total time of play for the round of golf by the golfer from the start time and the end time;

establishing a predetermined desired play time for playing the round of golf;

comparing the total time with a predetermined desired play time; and

offering a reward to the golfer when the total time is equal to or less than the predetermined desired play time.

In the method of rewarding the golfer, the step of establishing the predetermined desired play time is accomplished by management of the golf course according to expected playing conditions at the golf course prior to the round of golf by the golfer. The step of establishing the predetermined desired play time can include selectively changing the predetermined desired play time by the management during the round of golf by the golfer if there is a change of the expected playing conditions during the round of golf.

The step of offering the reward can include selectively establishing the reward by the management of the golf course.

When the golfer is one of a plurality of golfers and the golf course is one of a plurality of golf courses, the step of providing the readable device is for each of the plurality of golfers and the steps of calculating the total time and offering the reward are for any of the plurality of golfers playing the numerous rounds of golf at any of the plurality of golf courses. The method can include the steps of providing a central data base, recording each of the numerous rounds of golf for any of the plurality of golfers in the central data base, developing a playing history in the central data base for each golfer playing the round of golf at any of the plurality of golf courses, and selectively obtaining the playing history of any golfer from the central data base by management of any of the plurality of golf courses. The method of rewarding the golfer can further include the step of selectively offering additional different rewards to selected golfers included in the central data base.

The method of rewarding the golfer, when the predetermined number of golf holes is eighteen holes with the first golf hole being hole number one and the last golf hole being hole number eighteen and with a golf round break between hole number nine and hole number ten, can further include the steps of additionally first reading the readable device on the golf course at a beginning of a golf time break and recording a break start time, additionally second reading the readable device on the golf course at the completion of the golf time break and recording a break end time, calculating a total break time from the break start time and the break end time, and subtracting the total break time during the calculating of the total time of play for the round of golf.

The method of rewarding the golfer can further include the step for displaying at least the offering of the reward for the golfer on the golf course after the last hole when the total time of play is equal to or less than the predetermined desired play time.

In another alternative embodiment of the invention there is provided a system for rewarding a golfer for rapidly playing of a round of golf that includes a predetermined number of golf holes at a golf course. The system includes identification means for identifying the golfer and a recognition means located at a portion of the golf course near a first golf hole of the golf course and near a last golf hole of the golf course for recognizing the identification means at the beginning of the round of golf by the golfer prior to the golfer approaching the first hole and for recognizing the identification means at the end of the round of golf by the golfer after the golfer leaves the last hole. A control circuit is operably connected to the recognition means for recording a start time of the round of golf of the golfer when recognizing the identification means at the beginning of the round of golf and for recording an end time of the round of golf of the golfer when recognizing the identification means at the end of the round of golf. The control circuit is for determining a total time of play for the round of golf by the golfer from the start time and the end time. The control circuit is for comparing the total time with a predetermined desired play time for playing of the round of golf and for offering a reward to the golfer when the total time is equal to or less than the predetermined desired play time.

The control circuit of the system includes a feature for selectively changing the predetermined desired play time by management of the golf course, whereby the predetermined desired play time is capable of being established by the management according to expected playing conditions at the golf course prior to the round of golf by the golfer. Additionally, the features for selectively changing the predetermined desired play time by the management can be used during the round of golf by the golfer to change the predetermined desired play time if there is a change of the expected playing conditions during the round of golf.

The control circuit can include a feature for selectively establishing the offering of the reward by the management of the golf course.

The system for rewarding the golfer, when the golf course is one of a plurality golf courses in said system with each of said plurality of golf courses for separately rewarding a plurality of the golfers at said plurality of golf courses, can further include a central data base, a feature for recording each round of golf and each offering of the reward for each golfer in the central data base to establish a playing history of each golfer using any of the plurality of golf courses and a feature for selectively obtaining from the central data base the playing history for any one of the golfers by the management of each of the plurality of golf courses, whereby the management of each of the plurality of golf courses can use the playing history of any one of the golfers to select an appropriate starting time for any one of the golfers.

The system for rewarding the golfer can further include a feature of using the central data base to selectively provide additional offerings of different rewards to selected ones of the golfers.

When the predetermined number of golf holes is nine holes, the first golf hole is hole number one and the last golf hole is hole number nine. When the predetermined number of golf holes is eighteen holes, the first golf hole is hole number one and the last golf hole is hole number eighteen.

When the round of golf includes a golf round break between hole number nine and hole number ten, the system further includes the recognition means located near hole number nine and hole number ten for recognizing the identification means at a beginning of the golf round break after the golfer plays hole nine to cause the control circuit to record a break start time and for recognizing the identification means at a completion of the golf round break prior to the golfer playing hole ten to cause the control circuit to record a break end time, and the control circuit for determining the total time of play from the start time and the end time includes a feature for subtracting a total break time established from the break start time and the break end time.

In the system for rewarding the golfer, the identification means includes an identification card having a readable strip area including unique information to identify the golfer and the control means includes a course computer having a timing component, a programming function, a storage feature and a display screen. The recognition device includes a terminal operably connected to the course computer and the timing means thereof. The terminal includes a component for scanning the readable strip area of the identification card to collect the unique information for the course computer and to establish the start time and the end time.

The system for rewarding the golfer can include a display screen for displaying at least the offering of the reward for the golfer when the total time of play is less than the predetermined desired play time.

In another alternative embodiment of the invention there is provided a system for rewarding a golfer for rapidly completing a round of golf that includes playing a predetermined number of golf holes at a golf course with the round of golf by the golfer including the sequential playing of each of the holes of the predetermined number of golf holes of the round of golf following a preceding golfer playing a similar round of golf that includes the predetermined number of golf holes to result in a completion of the round of golf by the golfer after a completion of the round of golf by the preceding golfer. The system includes a first identification means for identifying the preceding golfer and a second identification means for identifying the golfer. A recognition means is located at a portion of the golf course at least near a last hole of the predetermined number of golf holes at the golf course and is for recognizing the first identification means at the end of the round of golf by the preceding golfer after the preceding golfer leaves the last hole and for recognizing the second identification means at the end of the round of golf by the golfer after the golfer leaves the last hole. A control circuit is operably connected to the recognition means for recording a first ending time of the round of golf of the preceding golfer when recognizing the first identification means at the end of the round of golf and for recording a second ending time of the round of golf of the golfer when recognizing the second identification means at the end of the round of golf. The control circuit is for determining an actual ending time differential for the round of golf by the golfer from the first ending time and the second ending time. The control circuit is for comparing the actual ending time differential with a predetermined desired round ending time differential after the end of the round of golf by the golfer following the end of the round of golf by the preceding golfer. The control circuit is for offering a reward to the golfer when the actual ending time differential is equal to or less than the predetermined desired round ending time differential.

The system for rewarding the golfer can include the recognition means also being located at a portion of the golf course near a first hole of the predetermined number of golf hole at the golf course. The recognition means is for recognizing the first identification means at the beginning of the round of golf by the preceding golfer prior to the preceding golfer approaching the first hole and for recognizing the second identification means at the beginning of the round of golf by the golfer prior to the golfer approaching the first hole. The control circuit is operably connected to the recognition means for recording a first starting time of the round of golf of the preceding golfer when recognizing the first identification means at the beginning of the round of golf and for recording a second starting time of the round of golf of the golfer when recognizing the second identification means at the beginning of the round of golf. The control circuit calculates an actual starting time differential for the round of golf by the golfer from the first start time and said second start time, and the predetermine desired round ending time is at least greater than the actual starting time differential.

In the system for rewarding the golfer, the predetermined desired round ending time differential can include the actual starting time differential plus a predetermined delay time. Additionally, the control circuit can include a feature for selectively establishing the predetermined delay time by management of the golf course according to the expected playing conditions at the golf course.

The system for rewarding the golfer includes the control circuit having a feature for selectively changing the predetermined desired round ending time differential by management of the golf course, whereby the predetermined desired round ending time differential is capable of being established by the management according to expected playing conditions at the golf course prior to the round of golf by the golfer and the predetermined desired round ending time differential is capable of being changed by the management during the round of golf by the golfer if there is a change of the expected playing conditions during the round of golf.

The system for rewarding the golfer can further include the control circuit having a feature for selectively establishing the offering of the reward by the management of the golf course.

In the system for rewarding the golfer, the first identification means can include a first identification card having first readable strip area including first unique information to identify the preceding golfer, the second identification means can include a second identification card having second readable strip area including second unique information to identify the preceding golfer. The control circuit includes a course computer having timing component, a programming function, a storage feature and a display screen. The recognition means includes a terminal device operably connected to the course computer and the timing component thereof. The terminal device includes a feature for scanning the first and the second readable strip areas respectively of the first and the second identification cards to collect the first and the second unique information for the course computer and to establish the first ending time and the second ending time.

Yet another embodiment of the invention includes a method of rewarding a golfer for rapidly completing a round of golf that includes playing a predetermined number of golf holes at a golf course with the round of golf by the golfer including the sequential playing of each of the holes the predetermined number of golf holes of the round of golf following a preceding golfer playing a similar round of golf that includes the predetermined number of golf holes to result in a completion of the round of golf by the golfer after a completion of the round of golf by the preceding golfer. The method includes the steps of:

establishing a predetermined desired round ending time differential for the completion of the round of golf by the golfer after the completion of the round of golf by the preceding golfer;

providing a first readable device for identifying the preceding golfer;

providing a second readable device for identifying the golfer;

reading the first readable device on the golf course at the end of the round of golf by the preceding golfer;

recording a first ending time of the round of golf during the reading of the first readable device;

reading the second readable device on the golf course at the end of the round of golf by the golfer;

recording a second ending time of the round of golf during the reading of the second readable device;

calculating an actual ending time differential for the round of golf by the golfer from the first ending time and the second ending time

comparing the predetermined desired round ending time differential with the actual ending time differential; and

offering a reward to the golfer when the actual ending time differential is equal to or less than the predetermined desired round ending time differential.

In the method of rewarding a golfer, the step of establishing the predetermined desired round ending time differential for the completion of the round of golf by the golfer after the completion of the round of golf by the preceding golfer can initially include the steps of:

initially reading the first readable device on the golf course at the beginning of the round of golf by the preceding golfer;

initially recording a first starting time of the round of golf by the preceding golfer during the initial reading of said the readable device;

initially reading the second readable device on the golf course at the beginning of the round of golf by the golfer;

initially recording a second starting time of the round of golf by the golfer during the initial reading of the second readable device;

calculating an actual starting time differential for the round of golf by the golfer from the first starting time and the second starting time; and

the establishing of the predetermined desired round ending time differential for the completion of the round of golf by the golfer includes causing the predetermined desired round ending time differential to be at least greater than the actual starting time differential.

The step of causing the predetermined desired round ending time differential to be at least greater than the actual starting time differential can include the step of adding a predetermined acceptable delay time to the actual starting time differential to produce the predetermined desired round ending time differential.

In the method of rewarding the golfer, the step of establishing the predetermined desired round ending time differential for the completion of the round of golf by the golfer can be accomplished by management of the golf course according to expected playing conditions at the golf course prior to the round of golf by the golfer. Additionally, the establishing of the predetermined desired round ending time differential for the completion of the round of golf by the golfer can include selectively changing the predetermined desired round ending time differential for the completion of the round of golf by the golfer by the management during the round of golf by the golfer if there is a change of the expected playing conditions during the round of golf by the golfer.

In the method of rewarding the golfer, the offering of the reward can include selectively establishing the reward by the management of the golf course.

### BRIEF DESCRIPTION OF THE DRAWINGS

FIG. 1 is a fragmentary, perspective view of a typical golf course installation which employs the preferred system for rewarding golfers for rapidly playing a round of golf and includes various features of the invention.

FIG. 2 is schematic diagram of the preferred system for rewarding a plurality of golfers including various features of the invention.

FIG. 3 is a typical program portion of the preferred system program demonstrating various features of the invention.

FIG. 4 is a fragmentary, perspective view of the typical golf course like that of FIG. 1 which includes an alternative installation which employs an alternative system for rewarding golfers for rapidly playing a round of golf and includes various features of the invention.

FIG. 5 is schematic diagram of the alternative system generally shown in FIG. 4 for rewarding a plurality of golfers including various features of the invention.

### DETAIL DESCRIPTION OF THE PREFERRED EMBODIMENTS

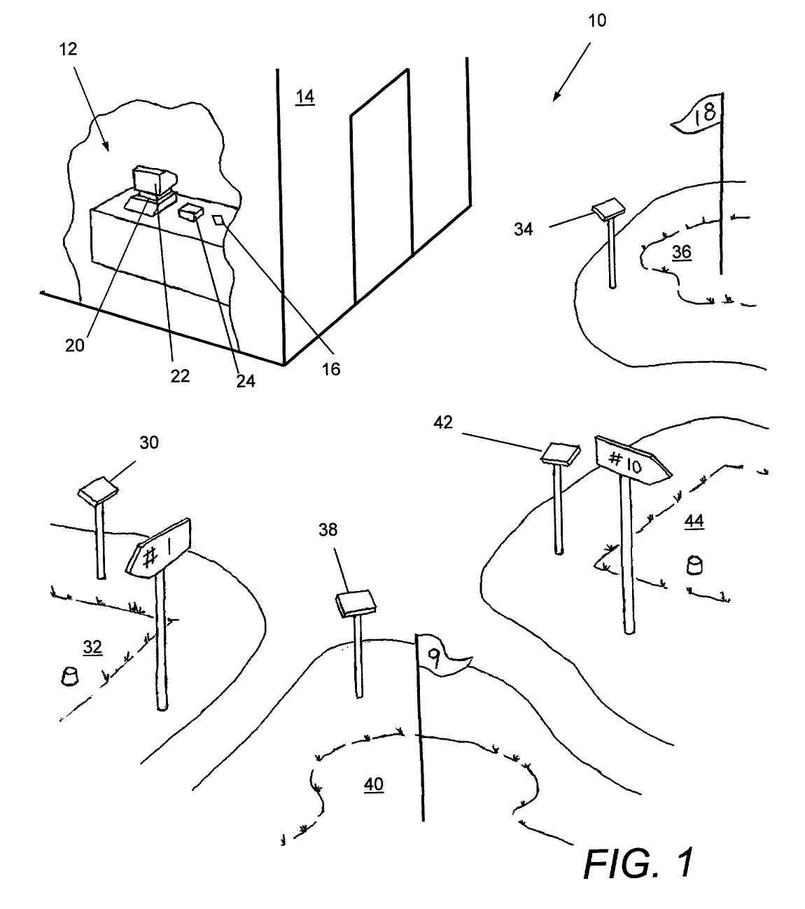

As seen in FIGS. 1, 2 and 3, a preferred basic system 10 for rewarding golfers for rapidly playing a round of golf is primarily controlled and monitored by control means 12 which is located in the pro shop of a golf course club house 14. As will be seen, the system 10 includes means for the management of the golf course to establish a predetermined desired golf play time for a round of golf, whether for nine holes or eighteen holes, and for rewarding those golfers that play the round within the predetermined desired golf play time or less. The preferred basic system 10 is more effective and more flexible but less complicated and probably less expensive than any of the devices or systems discussed above. The system 10 utilizes a “carrot” rather than “stick” approach to encourage and reward the rapid playing of the entire round of golf by each golfer for the benefit of the golfer, the golf course and the other golfers on the course.

Most of the prior art devices discussed above appear to be primarily applicable for golfing foursomes or twosomes during a single round because of the reliance on golf carts. However, the basic system 10 is primarily direct to each individual golfer and can be used to develop the playing history of the golfer, including rounds played at other golf courses that employ the basic features of the system 10 and participate in the overall features of the system 10.

For a golfer to be included in the system 10, the golf course would utilize the control means 12, which primarily includes a preprogrammed course computer 20 which typically includes key board and mouse means, timing means, data storage means and display means 22. Additionally, when using all aspects of the invention as discussed hereinbelow, the computer means 12 would be capable of utilizing a dedicated internet line or being selectively connected to the internet.

When a new golfer enters the system 10, management enters personal information about the golfer in the system program of the course computer 20. The personal information about the golfer includes his or her name and address and, perhaps, other information such as age, number of years playing golf, handicap or league information. Once the personal information about the golfer is in the system 10, it will be retained in the course computer 20 and, as will be discussed below, can be entered through the internet into a central data base of the system 10 that will include all of the golfers who have joined through any of the golf courses that are using the system 10.

For each golfer in the system 10, there is provided an identification means that can be used again and again at the golf course or any other golf course that also elects to employ all available aspects of the system 10. The preferred identification means includes a plastic card 16 having a readable strip 18 thereon that includes unique information that is assigned to a specific golfer. The preferred plastic cards 16 are issued in batch form with each readable strip 18 being a unique bar code of the type that is well known in the art. After the golf course has entered a specific golfer into the system 10, a plastic card 16 drawn from the batch will be assigned to the golfer for the unique bar code information on the card 16 to be entered into the system program and matched up with the golfer.

In order for this to be accomplished, the golf course would include a identification card reader device 24 that includes laser mean for recognizing the unique information contained in the bar code and is connected to the course computer 12 to transfer the unique information thereto. When the new golfer is initially entered into the system 10 by the golf course management, the plastic card 16 from the batch will be drawn through the identification card reader device 24 so that the unique information of the bar code strip 18 is matched with and assigned to the golfer and stored in the system program for future use. Once the unique information of the bar code 18 is in the system 10 and assigned to the golfer, the system program will “recognize” the golfer at any time in the future that the bar code strip 18 is identified and reported to the system program. Consequently, the preferred control means 12 would include the identification card reader device 24 which is operable connected to the computer 20 for access to the system program to enable the golfer to be conveniently recognized and identified within the system 10 by management by a simple reading the bar code on the card 16. Additionally, each card 16 preferably includes a “signature” strip 19 on the surface thereof so that the golfer will be able to sign and/or print his or her name on the new card 16 at the time of issuance for easy visual recognition and identification independent of the card reading device 24.

While the use of a card 16 is most significant to allow reliable and convenient use of the system 10, the particular card 16 and the unique information assigned to a golfer is only significant as it relates to the golfer and his or her personal information stored in the system program. Accordingly, if at some future date the golfer were to lose or misplace the card 16 previously assigned to him or her, a new card 16 with a new unique bar code thereon could be assigned to the golfer and matched with the personal information about the golfer in the system program to completely replace the unique information from the lost card 16. The new card 16 would then be capable of being used by the management or the golfer to cause the system program and the course computer to again recognize and identify the golfer in the system 10.

To understand the overall system 10, it is best to initially explain, by way of an example, the operation for a typical golf course using the system 10 on a typical day of golf. Each golfer, whether alone or in a group, would normally be assigned a starting times but would usually check-in at the pro shop prior to beginning. If all the golfers were not yet included in the system 10, the management would enter them and issue them a card 16. Since the golf starting time is often in the name of a single golfer, the management would be able to simply use the cards from each of the golfers in the group in the identification card reader device 24 to accurately record the group in the system to include each golfer for the specific assigned starting time.

To properly use the system 10, the management would establish prior to the beginning of golf for each day what the predetermined desired play time should be. For example, the management could decided for an eighteen hole round of golf, because of the expected playing conditions, that the first nine holes should require about one hours and fifty-five minutes and the second nine holes about two hours and fifteen minutes for a total expected time to play the round of four hours and ten minutes. These times would have been entered into the system program as the predetermined desired play times for these specific possible rounds of play and management would be able to tell the golfers the expected playing time for each nine and for a total time of four hours and ten minutes for all eighteen holes.

Additionally, management would have decided what would be the specific reward that would be offered that day to those golfers who were to play sufficiently fast to be able to complete the round of golf within the predetermined desired play time. The system 10 expects and relies on the management making such a decision and includes simple and effective means for allowing any reward that management considers appropriate. For example, management could offer a free sleeve of balls and a coupon for twenty-five percent off a pair of golf shoes for rapid play throughout the eighteen holes or might even let the golfer select a reward from a list. Such rewards would be totally within the discretion of the management and could be changed from day to day. The rewards could be used to sell pro shop inventory, could be designed to promote the snack bar, or might include a reduction in the cost for the next round of golf in order to increase the play at the course. The management would probably develop the rewards over time according to what works and what best serves both the golfers and the golf course. It is expected, for the system 10 to be most effective, that management would want as many winning golfers as possible and would assign a realistic predetermined desired playing time. Accordingly, most golfers could, with due diligence and attention to their play, be expected to receive the offer of the reward. It may not be the value of what the golfer “wins” that counts but simply the concept of the golf course being willing and able to reward those that play rapidly that would cause the golfers to attempt to do their best.

Although the personnel in the pro shop or the starter at the first hole would typically “remind” each golfer of the predetermined desired play time and the possibility of a reward after the round, it would be up to management to determine when the golfers are informed of the exact nature of the rewards that are being offered. It is possible that the suspense of what might be received at the end of a round would be a greater incentive for rapid play than the knowledge of what the reward would actually be. It is even possible that a golfer who has knowledge of but is not interested in a particular reward might not do his or her best. Again, the system 10 is sufficiently flexible to expect and allow the management to choose the manner and method that might best be used at that particular golf course. While the management of any course may learn from what other courses in the system are trying and find successful, it remains the responsibility of management to use the system for the best results possible for its particular golf course.

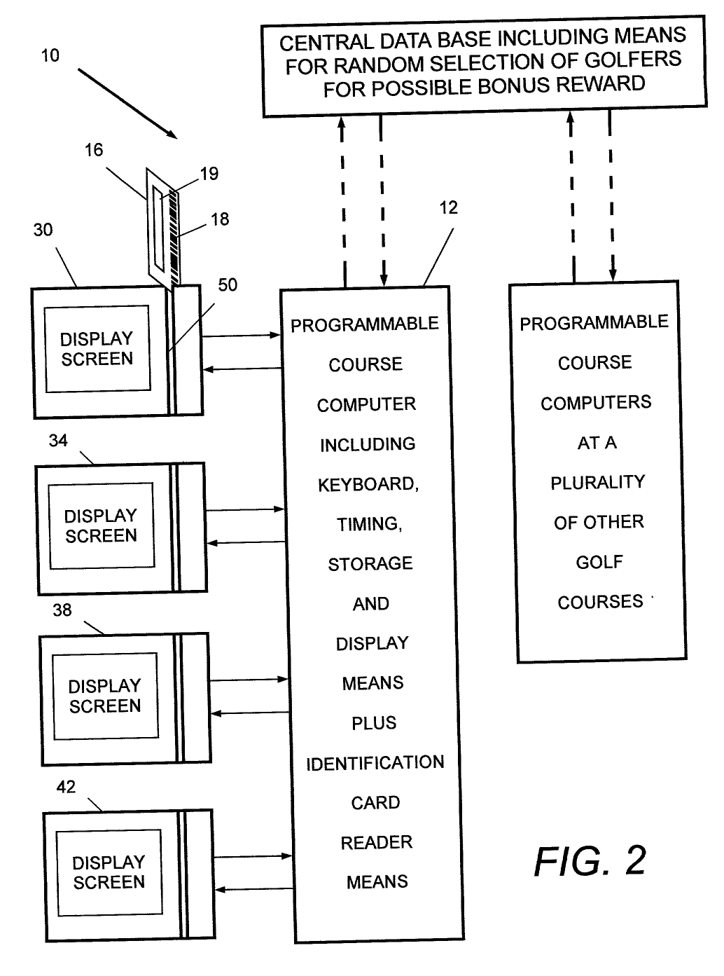

With the predetermined desired play times and the particular rewards selected and entered into the system program of the course computer 20, the course personnel at the pro shop would remind the golfers checking in prior to a round to used their identification cards 16 and direct them to the first tee. As seen in FIGS. 1 and 2, the typical golf course using the system 10 would include at least eighteen holes and might be configured for a “break” between the ninth and tenth holes. In order to be able to determine when each individual golfer starts and ends the round of golf being played, a means for recognizing the identification card 16 of each golfer is physically located at the beginning and the end of each round and must be operable connected to the control means 12 and the course computer 20 thereof. Despite the assignment of a starting time for each golfer, the golf course management is interested in the actual playing time and, therefore, the actual start time and end time. It is not uncommon for golfers to collect at the first hole and for the assigned starting times to be adjusted or delayed as the various groups begin playing.

Accordingly, prior to the first golf hole, Hole No. 1, a first terminal 30 is mounted at the tee area 32. A second terminal 34 is located after the last hole, adjacent to the green area 36 of Hole No. 18. Because of the possibility of a “break” being taken in the middle of a eighteen hole round of golf, a third terminal 38 is located adjacent the green area 40 of Hole No. 9 and a fourth terminal 42 is located adjacent the tee area 44 of Hole No. 10. The terminals 30, 34, 38 and 42 are preferably connected to the computer 20 by underground wiring (not shown) to send information to and receive information from the computer 20. As best seen in FIG. 2, each of the terminals 30, 34, 38 and 42 includes a display screen and a card reading slot 50, along which the card 16 will be passed, for recognition of the bar code strip 18 and identification of the particular golfer using the terminal. Such terminals are well known for numerous business purposes and could be of the general type which is manufactured and sold under the trademark TRAKKER ANTARES T2481 by Intermec Technologies Corporation. Additionally, because of being operably connected to the computer 20, passage of the card 16 of a golfer along the slot 50 will cause the start time, end time, break start time and break end time to be recorded for each individual golfer depending on which terminal 30, 34, 38 and 42 is being used. The system program is configured to record each “time” for each golfer playing a round of golf and to calculate total play time for comparison with the predetermined desired play time. If the golfer is playing eighteen holes without a break, the total time would basically be the difference between the start time at terminal 30 and the end time at terminal 36, whether he or she chooses to use terminals 38 and 42 or not. With the total time for playing the round of golf being equal to or less than the predetermined desired play time, which in the present example would be four hours and ten minutes, the golfer would be offered the selected reward by the management of the course. If a golfer is playing eighteen holes but wishes to take advantage of the golf break between Hole No. 9 and Hole No. 10, the system program would effectively use the break start time and the break end time recorded at terminals 38 and 42 to subtract the total break time from the difference between the start time and end time in the computer to calculate the total time for actually playing the round.

When each of the golfers begins the round, he or she will insert his or her card in the slot 50 of terminal 30 to record the start time and receive an appropriate message on the display screen. It should be noted that when a group plays a round of golf, each golfer might use the terminal 30 but it would not be uncommon for one of the golfers to “collect” all of the cards 16 and to draw them one after the other along the slot 50. In either case, the messages on the display screens would be the same and could be related to the others in the group by the selected golfer. In this first example, the golf course does not mind and may even encourage break times. The message on the display screen could be, “The time is 11:55 AM and the expected play time for the first nine holes is 1 hr. and 55 min., to be completed by 1:50 PM, and for the second nine holes is 2 hrs. and 15 min. You should complete the overall round in 4 hrs. and 10 min. not counting the time for a break. Have a nice round, Mr. Smith.”

Since, with the system 10, the overall play time will be more important for all the golfers, allowing other groups to play through if a group decides to take a break could be encouraged and would be more readily accepted. In such a case, the display screen of terminal 38 after Hole No. 9 might include the message, “Congratulations, Mr. Smith. You have completed the first nine holes in ten minutes less than the desired play time. If you wish to take a break, understand that following groups may be allowed to play through at the next hole.” If the group is playing slow, the message might be, “Unfortunately, Mr. Smith, you have completed the first nine holes in ten minutes more than the desired play time. If you wish to take a break, understand that following groups may be allowed to play through at the next hole. When you continue, you should speed up your play or be willing to let other groups play through.”

After the break, the golfers would use the terminal 42 and, if the play had been rapid, the following message could be, “The time is 2:15 PM and, with 10 min. saved on the first nine and an expected time of 2 hrs and 15 min. for the next nine, the round should be completed by 4:40 PM to receive a reward. Good luck, Mr. Smith.” If, on the other hand, the play had been slow, the message might be, “The time is 2:35 PM and, with 10 min. lost on the first nine and an expected time of 2 hrs and 15 min. for the next nine, the round should be completed by 4:40 PM to receive a reward. Please speed up your play or be willing to let other groups play through. Good luck, Mr. Smith.”

It should be noted that some golf courses might not wish the golfers to take a break time, for example, on weekends. Such courses believe that the breaks tend to slow down overall play and, therefore, might not allow the terminals 38 and 42 to be used to subtract the break time. As long as the golfers are advised of the preferred system being used by the management, the system 10 would be capable of being configured for this purpose. In such a case, when a golfer begins to play and uses terminal 30 at Hole No. 1, a message on the display screen might include, “The time is 11:55 AM and the expected play time is 4 hrs. and 10 min. with no time being subtracted for a break. You should complete the round by 4:05 PM. Have a nice round, Mr. Smith.” When the group completes the first nine holes and uses the terminal 38 after Hole No. 9, the display screen would include a message such as, “Congratulations, Mr. Smith. You have completed the first nine holes in ten minutes less than the desired play time after nine holes. You should complete the round by 4:05 PM to receive a reward. Since the time for a break will not be subtracted from your overall play time you should go to the next hole or be willing to let other groups play through.” If the group is playing slowly, the message might be, “Unfortunately, Mr. Smith, you have completed the first nine holes in ten minutes more than the desired play time. Since the time for a break will not be subtracted from your overall play time you should go to the next hole and speed up your play or be willing to let other groups play through.”

In either case, the golfer as he proceeds to Hole No. 10 may not actually use terminal 42. Because only the overall time is considered in this second example, the system program would not require any break end time and would be configured to properly function whether terminal 42 is used or not. If the golfer uses terminal 42 because of habit or previous practices, the message appearing thereon would be about the same as that having been shown on terminal 38.

Whether the management using the system 10 for the particular course and day expects the golfer to take a break or not, after the eighteen hole round is completed, each golfer would use the terminal 34 to record the end time. The system program would calculate the overall play time and make a comparison with the predetermined desired play time. Again, the system 10 would be capable of using such calculations for each golfer and providing a message for the display screen of terminal 34 to inform the golfer of his or her receiving of a reward for the just completed round of golf. For example, the message for a golfer who has played the round in less than the desired play time might include, “The time is 4:35 PM. Congratulations, Mr. Smith. You have completed the round in 15 min. less than the expected play time. Please proceed to the pro shop to receive a reward for your efforts which are appreciated by management and other golfers on the course.” If the golfer is in a group that played too slowly, the message might be, “The time is 4:55 PM, Mr. Smith. Thank you for playing at our course and we hope you had a good day. Although your playing time exceeded the expected play time of 4 hours and 10 min. by 5 min., you are a valued guest and we hope you join us again in the near future.”

These two examples might appear at first to be complicated and difficult to provide because of the different messages at the different terminals. However, the system program includes means for mostly accomplishing these tasks automatically after only a basic amount of information has been supplied by golf course management for that particular day of golf. The system program would allow the golf course management to select whether or not a break time will be recognized and subtracted and, depending on the selection, would offer a number of typical messages that can be used for the various round playing situations. As a result, management would be able to select the predetermined desired play times and the desired messages that would be used according to the time calculations that are made during and after the round of golf for each golfer. After the basic times and messages are selected from the system program, the computer means 12, when prompted by the use a card 16 at any of the terminals, would recognized the golfer, record the time and make the necessary calculations and then simply insert the name of the golfer and the times as calculated into the appropriate messages that are to be sent for display at the particular terminal 30, 34, 38 or 42 for the golfer.

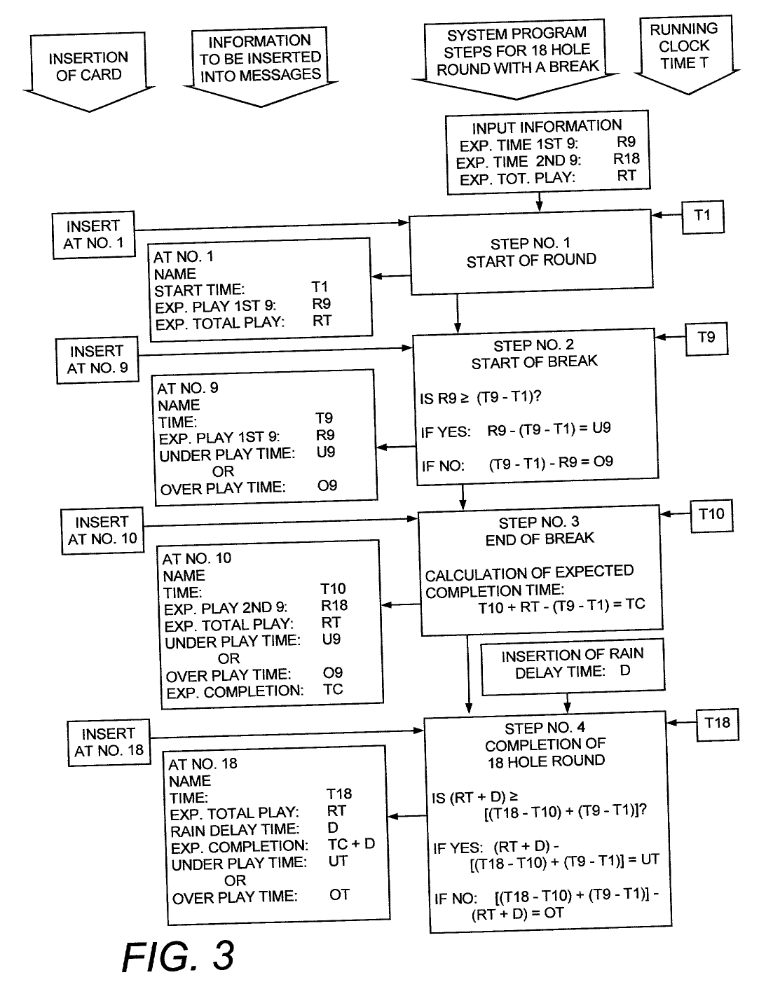

As seen in FIG. 3, the operation of a particular program portion of the system program is disclosed to demonstrate how the various information is provided to the program and how this information is used to make the necessary calculations and decisions for the messages to be displayed at the terminals 30, 34, 38 and 42. The particular program portion of the system program of FIG. 3 is for a golf round that would include eighteen holes of golf with a possible break between Holes No. 9 and No. 10 and with the capability of adding additional time to the desired expected play time. It should be clear that other program portions are included in the preferred system program and could be selected if desired by management. For example, other program portions might include eighteen holes with no break, eighteen holes starting at hole ten with a break after hole eighteen, only nine holes or any number of other combinations which might be preselected by the golf course management.

The overall operation of the portion of the program shown in FIG. 3 should be clear after the discussion provided above but will better demonstrate the relationships that exist between the various terminals on the golf course and the computer 20 including the system program and a the running clock for determining the time T. The signification actions include the steps taken within the program portion of the system program, the insertion of the card by a golfer at the various holes, the recording of the time of each insertion and the messages which are sent to the terminals after the insertion of the card at the terminals.

Prior to the round of golf, the management would have selected the program portion for eighteen holes with a break and with the ability to adjust the desired play time (which will be discussed in detail hereinbelow) and would have selected all of the appropriate messages that would be sent to the various terminals depending on the playing times by the golfer as they relate to the desired expected play times. The management would input information into the program portion to record the desired expected time for the first nine holes R9, the second nine holes R18 and the total round RT.

When the golfer inserts a card in the terminal at the first hole, the portion of the program would recognize the golfer by name, the start of the round, record the start time T1 and provide the appropriate information as shown for insertion into the selected message for Hole No. 1.

After the first nine holes have been played, the golfer would insert the card in the terminal at Hole No. 9 and the program portion would recognize that the golfer was in a position to start the break and record the beginning of the break time T9. With the information included in the program, the program portion would determine if the desired expected play time for the first nine holes R9 was equal to or exceeded the actual play time from T1 to T9. The results would determine which message should be sent to the terminal at the ninth hole and, with the calculation of either the under time U9 or over time O9 for the nine holes, the required information would be available and used to provide the appropriate message for the display screen on the terminal at Hole No. 9.

After the break, the golfer would insert the card in the terminal at the tenth hole to cause the program portion to again recognize him or her by name and to record the end of the break time T10. The break time T10 and other information in the program portion would be used to calculate the expected completion time TC. The completion time TC would be obtained by subtracting the actual time for the play of the first nine holes from the desired expected play time RT for the total round and adding the results to the end of the break time T10. Based on the calculations and the message sent at the end of the first nine holes of play, the program portion would again use the various times to be able to send an appropriate message to the display screen at the terminal at Hole No. 10.

While the golfer is playing the second nine holes, there is rain or a bad weather condition on the course that clearly interrupts play. Because of such a condition, which is clearly out of the control of the golfer, it would be doubtful that any of the golfers still on the course would be able to complete the round in the desired play time RT. Accordingly, in order to allow the management to reward the golfers despite the interruption in play, the program portion includes, for example, means of adding a rain delay time D which will be used to adjust the times for the round and to inform the golfers of this fact at the next available terminal. While this feature will be further discussed in detail hereinbelow, the additional time D would basically be added to the expected total play time RT in the remaining calculations.0

At the end of the round, the golfer would insert the card in the terminal at the last hole to cause the program portion to record the completion time T18. Initially, the program portion would determine if the expected total play RT plus the delay time D are equal to or greater than the actual playing time as calculated from the time for playing each of the nine holes of golf. Depending on the results, the appropriate message would be selected to indicate whether or not the play was sufficiently rapid for a reward to be offered. In either case, the times would again be used to either calculated the under time for the total round UT or the over time for the total round OT. The appropriate message including the name of the golfer, the time T18, and information about the time delay for rain would be included in the message indicating that the golfer would or would not be offered a reward for rapid play.

Although the examples provided appear to include standard messages which are simply selected from an available list, the system program would include means of allowing the management of edit or create its own messages for special or unusual circumstances. For example, the first message may, if desired by the management, indicate that the reward for rapid play will be a free sleeve of balls to encourage each golfer not to waste time looking for a lost ball. Such information provided before the round might help those playing with a slow golfer to get him or her to speed up play. The management may wish to add a message for all golfers that appear to be particularly slow, for example, twenty five minutes over the expected time, to report to the pro shop after the round so that efforts could be made to insure that the group understood the system and the need to let other groups play through or to see if there is a problem that might be corrected prior to the next round.

The system program would include a means for “tracking and following” each golfer on the course and eventually recording the various play times as they relate to the predetermined desired play time for each golfer. Consequently, if a golfer were to report to the pro shop as requested because of excessive play time, the personnel in the pro shop would be able to use display screen 22 of the computer 20 to identify the golfer and those golfers playing in front of and after the golfer for purposes of analysis. By reading the various times, including whether the golfer and his group allowed others to play through, the management would be able to ask the exceptionally slow golfers to play differently the next time or instruct them on how to play quicker in the future.

It should be clear to those skilled in the computer programming art that any number of features could be incorporated into the basic system program that would add flexibility for the management but would still not require unnecessary or excessive time for the management to alter and adjust the system 10. For example, after a basic play situation and messages are selected by management, the resulting program could be saved in the computer 20 for use from day to day and might only be changed if the predetermined play times are changed. On the other hand, the overall system program would also be capable of being adapted for other special circumstances.

For example, because of league play or a private group outing in the afternoon, the predetermined desired play time might be lengthened during the day for those in the league or outing and for those groups of golfers following the league or outing. The predetermined desired play time for those following the league or outing, which might include slower players, would also be altered to insure that they are not penalized because of the inability to play through the last groups of the league or outing while they are still on the course. Similarly, if it has been found by the management of the golf course that most week day afternoons include less experienced and thus slower playing golfers, the system program may be readily changed for subsequent golfers to generally increase the predetermined desired play time to reflect such a situation and possibly offer a reward to those golfers who nevertheless attempt to play a rapidly as possible under the circumstances.

Because the control means 12 would, as discussed above, allow each golfer and the group he or she is in to be “tracked and followed” on the computer 20, the preferred system 10 would included a system program that would not only be selected for a particular day or for a particular afternoon but could even be adapted for the individual golfer or groups of golfers on the course. For example, as discussed above for a rain delay, the preferred system would include means for actually altering the predetermined desired play time for a golfer during the round if desired by management because of a temporary change in playing conditions. As a result, at the beginning of a particular day, management might have expected and thus selected a desired play time of four hours and ten minutes and have so informed the golfers in all the groups on the course. However, during the round, because of rain and lightening, play throughout the course was discontinued for about thirty minutes and was only resumed after the conditions had returned to normal. Because management would not want the golfers to continue to play under such conditions, the preferred system program would include means for adding thirty-five minutes, or any other appropriate time, to the predetermined desired play time of each individual golfer on the course. Again, the system program would accommodate such a contingency and would even include appropriate additions to the messages to inform the golfers of the changes being made. To those skilled in the programming art, such a change would not be as complicated as it might first appear. To add the rain delay time for each golfer, the pro shop personnel would simply select, as a group, all the golfers on the course at the time and add thirty five minutes to the expected play time for the selected golfers in a portion of the system program intended for this purpose. At the same time, a sentence would be automatically added by the system program to the various messages for display and might simply include an additional sentence added to the regular message, such as, “Because of rain on the course, 35 min. has been added to the expected play time.” The new expected play time, with the thirty five minutes added, would be used for all of the subsequent calculations and messages.

After the rain and lightening condition have passed, the golfers that subsequently begin a round of play could return to the original predetermined desired play time or one that might have been adjusted by management because water on the course. Although these golfers might have been delayed in the start of their round because of the rain delay and other golfers scheduled to start before they were to start, they would not receive credit for the rain delay which would be over prior to their entering the system at the first hole.

In the examples provided above, the system 10 has been used by a golf course that accepts only golfers that intend to play an eighteen hole round of golf. However, a number of courses operate on the assumption that many golfers will only wish to play nine holes in a round. If only nine holes are being played, the golfer's times at terminals 30 and 38 or terminals 42 and 34 would be used for comparison with the respective predetermined desired play times for the particular nine holes to determine if a reward should be offered. The overall system program would include a portion that could be selected by the management to keep separate records of the time for each nine hole and to offer a reward for rapid play on either or both of the nine hole rounds. If a golfer is scheduled for eighteen holes and has been assigned a starting time for the both halves of the full round, he or she might be eligible for either or both rewards if desired by management. On the other hand, the system program could be directed to provide a unique reward for the golfer who plays the entire eighteen hole within the predetermined desired play time but would not be eligible for the rewards for rapid play of the separate nine holes. Again, this would not be as complicated at it might first appear because of the flexibility and adaptability of the preferred system program. With different conditions being desired by management for a nine hole round and an eighteen hole round, both programs would be selected to include unique messages and rewards and would, with the preferred system program, be automatically selected for the golfer when he or she checks in at the pro shop to begin either a nine hole or an eighteen hole round.

Similarly, it is not uncommon for some golf courses to be configured to some times allow golfers to begin play for nine or eighteen holes on Hole No. 10. Such conditions might occur, for example, if the first nine holes are being used by a league that will be expected to be completed before those completing the second nine holes will return to the first nine holes to complete the round of eighteen holes. Again, the system program is configured to accommodate such a condition and, with the proper information being included in the program to recognize that a golfer is beginning on Hole No. 10 and intends to finish on Hole No. 9, the same type of calculations, records and messages can be sent to the appropriate terminals 30, 34, 38 and 42 to advise the golfer of his progress and to insure that a reward will be offered for the separate nine holes or the total eighteen holes as appropriate.

As explained hereinabove, the preferred system 10 will include means for accommodating play on either or both of the nine holes, play of leagues or outings and play when conditions change during a particular day or in the middle of a round. In any case, the system 10 will conveniently allow the management to select and offer rewards for rapid play which is consistent with the objectives of the golf course and with the desires and abilities of those golfers using the course.

However, the system 10 not only records the activity of the golfers while they are on the course to allow a change when required and to monitor their activity and results for a particular day but will include a record of the play of each golfer for future reference and use. Accordingly, the results of each round will be retained for each golfer and will be available to the management of the course from the system memory upon demand. This capability can be very useful to the management for proper golf course management. For example, after an outing or with repeated use by a league, the management will be able to better determine how much time to allow for these event and to plan the predetermined desired play time accordingly. Additionally, with full use of the system 10, it is expected that when a golfer calls for a tee time, the management will be able to examined the playing history of the golfer, understanding that he or she may not always play with the same group, to see if he or she tends to play rapidly or slowly. If the golfer play rapidly, the course might try to assign a starting time in the morning so as to keep the flow and pace of play rapid all day. On the other hand, if the golfer tends to play slowly and appears to have difficulty playing at the normal expected rate, the management might suggest that the golfer play after an outing or league where the pace will be slower and the golfer will be more likely to play in less than the expected time and to receive a reward for his or her efforts. If management determines that the golfer has a history of slow play and is assigned a starting time in the afternoon but with no league or outing to insure a slower time, the management would be advised to clearly inform the golfer of the golf course policy of rewarding rapid play and the possibility of allowing other groups to play through if necessary. Still further, in a worse case situation, the management may refuse to give a time when rapid play is clearly expected and the golfer would be placed in an uncomfortable position of playing among a number of golfers what would be unduly delayed and attempting to repeatedly play through in order to be able to receive a reward.

For this purpose, it would be clear that the entire playing history of a particular golfer would be available at the golf course at which he or she is a frequent player. However, because the total information may be too difficult to quickly analyze, the system program will include means for selectively presenting basic information that may be more useful to the golf course management. For example, the management may be able to select only the history for the last six months or an indication of the number of rounds that are nine holes, eighteen holes, on a week day, on a weekend, with a league or in an outing. Additionally, the system program could be directed use the rounds from the total history or just the last six months to indicate the total times that were played and the number of rewards that had been offered to produce a resulting percentage to see if the player is above or below the average of the golfers for the golf course.

As explained hereinabove, the examples provided are for the use of a single golf course and for the golfers that use that golf course. It is clear that the system 10 can be effectively used by the management to reward golfers for rapid play and to better control the use of the course to the benefit of the management and all of the golfers using the course. It is also clear that the system 10 is easily adaptable for other courses and that any number of such courses might separately and effectively use the system totally independent of the any other golf course that might also use the system.

However, as mentioned above, the system 10 preferably includes other aspects which will tend to encourage a golf course using the basic features of the system 10 to selectively share the information and advantages of the system with other courses using the system 10. For this purpose, the preferred control means 12 at each golf course includes means for being operably connected to a central data base which will contain information about each of the golfers from any and all of the golf courses which have elected to use all aspects of system 10. Connection and access to the central data base would preferably be by the internet and would allow any golf course in the system 10 to retrieve and examine the playing history of any of the golfers therein. The central data base would also be expected to contain information about each of the golf courses in the system 10, including, for example, location, course data, course policy and any other information that might be useful to a golfer when trying to select a course in the area or elsewhere in the country that also uses a means for rewarding rapid play with the system 10.

Each golf course in the overall system 10 would be expected to insure that the golfer initially using the course and being entered into the system 10 is also entered into the central data base. Further, each round of golf being played by the golfer will also be reported for inclusion in the central data base whether the golf course is continuously on line with the central data base or simply down loads the daily results at the end of each day.

The reasons for and the advantages of each individual golf course being connected for access to the central data base are numerous and varied.

First, any golf course would want the system 10 to be accepted and recognized by as many golfers as possible. The golf course would welcome golfers that are used to and begin expecting the time for playing a round of golf to be controlled through the use of the system 10 for rewarding rapid play. The more golfers that use and appreciate the system 10, to more likely a golfer in the area will return to the golf course to play a round of golf. If a golfer uses the systems 10 at another golf course in the area or in another region of the country, it is the more likely that he or she will use other golf courses that also use the system.

Second, by joining the overall system 12, information about the golf course would be included in the central data base so that the management at another golf course would be able to inform a golfer of other golf courses in the system that might be in the area or elsewhere in the country. It should be understood that a number of golf courses using the system 10 might be located in resort or vacation areas and could be selected for play by travelers or vacationers because of the knowledge of the system 10 and the rewards and benefits that might result from playing at a golf course using the system 10. On the other hand, even if a golf course using the system 10 does not expect many travelers or vacationers, the overall acceptance and enjoyment of the system 10 would tend to attract golfers who might wish to be included in the central data base and be able to select a golf course and obtain a tee time at a other courses in the system 10 when traveling or vacationing in the other areas of the country.

Third, the management of a golf course will be able to use the history of a golfer, including the history established when playing other courses in the system 10, to help assign a proper starting time for the golfer which will be better for the golfer and others that might be playing at the same time on the course. Golf courses at resorts or vacation areas would be more likely to have a golfer seek a tee time about whom little is known. Such golf courses would be able to collect the entire history of the golfer or, more likely, would tend to customize the system program to be able to select only a portion of the information in the central data base to reduce it to a form that would be easier to analyze. For example, the management of the golf course might simply select the name, address, handicap, and playing history of weekend rounds of golf by the golfer and a list of all of the golf courses at which the golfer had played.

These specific advantages of using the central data base of the system 10 are primarily for the golf courses which would have access to most of the features included in the central data base. However, as more golfers are entered into the system 10 and more golf courses use the system 10 and begin to take advantage of the central data base, it is expected that the central data base would be expanded to allow limited access to the golfers in the system and to the general public. As a result, the reasons for and advantages of the various golf courses to use all aspects of the system 10, including central data base, would continue to grow.

Fourth, with the central data base being expanded to allow limited access through the internet, specific but limited information therein would be made available to all the golfers in the system 10 and to the general public. For example, the public access portion of the central data base would include a detailed explanation of the system 10 to educate the public. There would also be included promotional information about each golf course using the system 10 to help and encourage a golfer to select other golf courses located throughout the country that use the system 10 for a round of golf.

Last, and perhaps more importantly, the central data base of the preferred system 10 would be used to randomly select golfers, from all of the rounds of golf played in the system during a particular time frame, to receive special rewards for simply using the system. The special rewards would be significantly more valuable than anything that a single golf course might be able to offer. For example, the rewards might include a fully paid golf vacation to one of the member golf courses, golf clubs and bags, or fully paid golf lessons at a member golf course of the golfer's choice. After the rewards are given to the various golfers selected from the central data base of the system 10, it is expected that the results would be posted on the public access portion of the central data base on the internet to further promote the system 10 to the advantage of all of the golf courses and golfers using the system 10.

From all of the examples provided hereinabove, it should be clear that additional alterations could be made to either the basic features or the more extensive aspects of the system 10 while remaining within the scope of the invention as claimed. For example, if a golf course were to be interested in only those golfers that play a full round without a break, the terminals at Hole No. 9 and Hole No. 10 could be eliminated. The identification cards might be of the magnetic strip type that contain specific information about the golfer rather than simply a code that can be assigned to the golfer. While the preferred system 10 utilizes hard wiring connections, the system could be alternatively configured to use a wireless radio communication means to insure that each of the terminals is operably connected to the computer 20 to supply the desired information from the terminals and is send the messages from the computer 20. Such terminals which use wireless radio communication are manufactured and sold under the trademark TRAKKER ANTARES T2486 by Intermec Technologies Corporation and would be used in conjunction with a comparable transceiver connected to the computer.

Having explained the preferred system 10, it should be clear to those skilled in the art that some specific alterations could be made without departing from the overall objectives of the invention. It will be seen that the alterations would be generally capable of providing the same general objectives of the system 10 but would be able to do so by utilizing different components and different methods of operation that would be clearly within the skill and capabilities of those in the art after understanding the detailed description provided above with the aid of the information provide in FIGS. 1, 2 and 3. For example, with the detailed teaching of the preferred embodiments discussed hereinabove, it will be clear that with the teaching of the alternative embodiments hereinbelow that a detailed system program, similar to that of FIG. 3, could be developed by a skilled programmer to practice the invention as defined herein for the alternative embodiments.

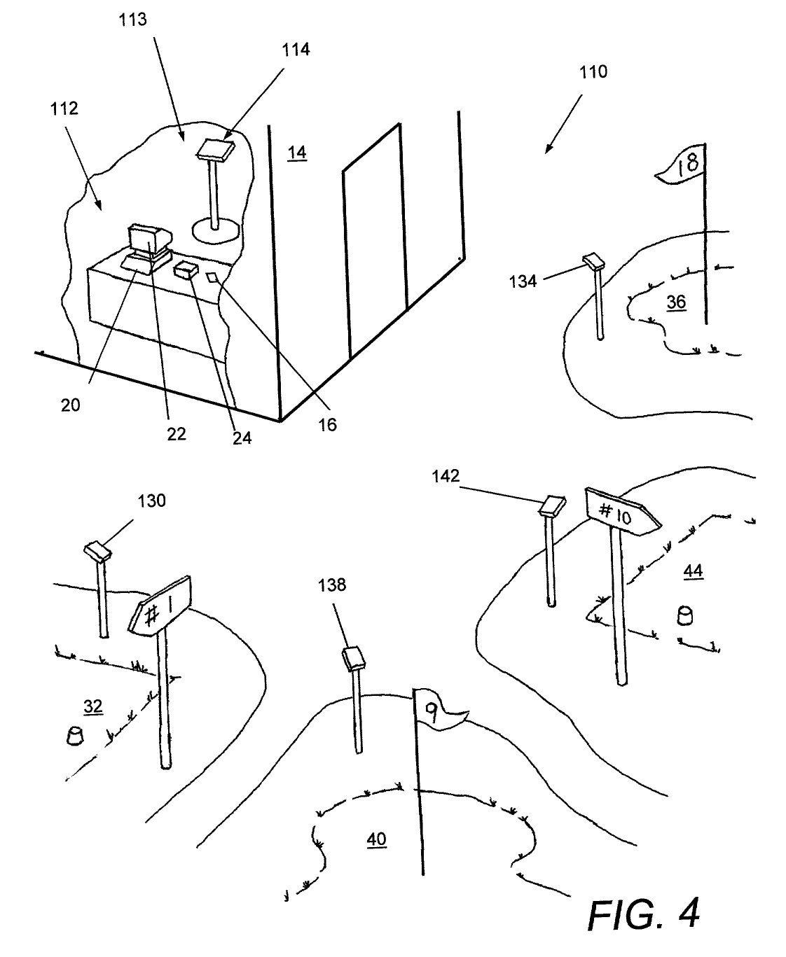

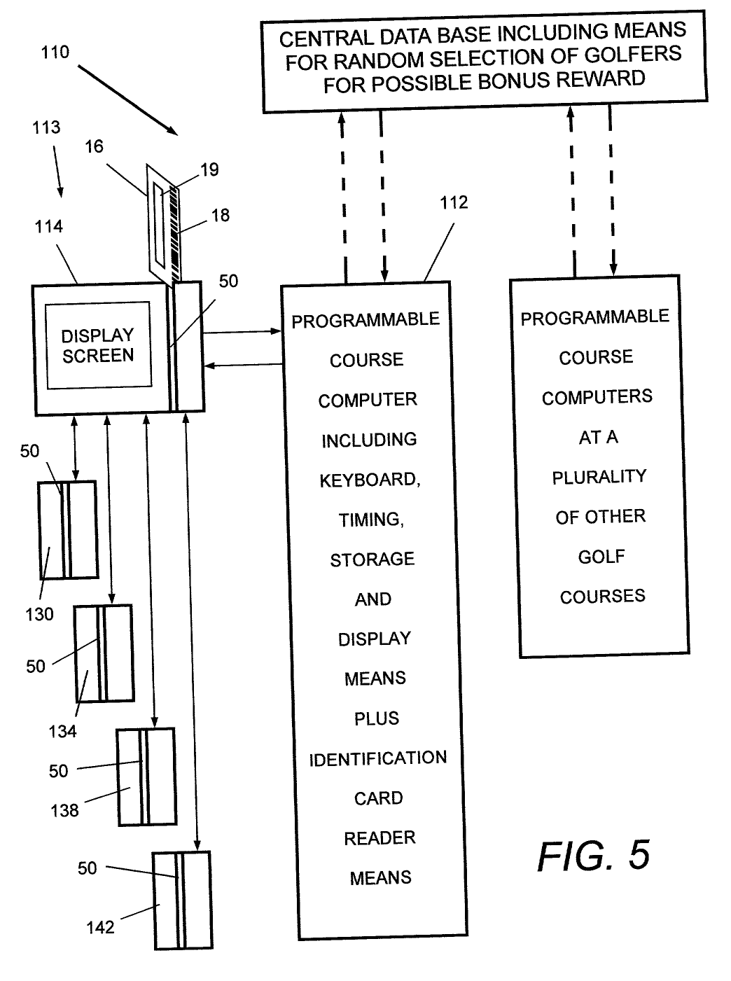

Specifically, as seen in FIGS. 4 and 5, an alternative system 110 is for use on the same or a similar golf course but will use a different control means 112 because of the different components employed. Generally, the alternative system 110 will not require the preferred but more expensive terminals 30, 34, 38 and 42 which include display screens and, in some areas of the country, might be more susceptible to damage because of bad weather or abuse. Nevertheless, the system 110 will utilize the alternative control means 112 which will be installed in the club house 14 as was the control means 12. The system 110 would again employ an identification means which includes the plastic card 16 having the readable strip 18 that is assigned to a specific golfer. The golf course would again employ an identification card reader device 24 which is connected to the alternative control means 112 to allow the various golfers to be installed in the system 110 in the same manner as described hereinabove.

Once installed in the system 110, the golfer would again be able to qualify for rewards if able to play the round of golf in the predetermine desired play time. However, rather than using the various terminals 30, 34, 38 and 42 which include display screens and results in specific messages being provided at each terminal, the system 110 employs a recognition means 113 that includes a terminal 114 located within the club house 14 and associated card readers 130, 134, 138 and 142 respectively located at the Holes No. 1, 9, 10 and 18. The golfer would initially use the terminal 114 of the recognition means 113 which has a display screen similar to those discussed above. When the golfer is “signing in” at the card reading slot 50 of the terminal 114, the control means 112 would recognize the golfer and display a welcoming message and instruct the golfer on the proper use of the various card readers 130, 134, 138 and 140 of the recognition means 113 in order to properly establish and record the starting time, the break starting time, the break ending time and the ending time. Accordingly, with the proper system program in the computer 20 of the control means 112, the golfer will again be informed whether he or she qualifies as a “winner” when he or she “re-signs in” at the terminal 114 upon the completion of the round of golf. As with the system 10, the system 110 will include means to establishing the total time of play of the round of golf and then comparing it to a predetermined desired play time for the possible offering of a reward to the golfer which reward has been selected by the management. Similarly, the system 110 could include means for selectively changing the predetermined desired play time by the management according to expected playing conditions. There would again be included means for selectively changing the predetermined desired playing time if there is a change of the expected playing conditions during the round of golf. Still further, the system 110 would include the means for providing additional offerings of different rewards for the golfer in the same manner as described by establishing a playing history and through the use of the central data base.

The system 110 would thus generally operate in the same manner as the system 10. However, those skilled in the art will see that the system 110 (and in some situation the system 10) can be further altered to still accomplish the desired objectives but with fewer and/or different basic components.

For example, the system 110 can be reduced to only included the terminal 114 if it is properly located near Hole Nos. 1, 9, 10 and 18. If the single terminal 114 is used, the control means 112 would be appropriately altered to lengthen the predetermined desired playing time to allow for the additional distant that the golfer would have to go to arrive a Hole No. 1 and Hole No. 10 from the club house 14 and to return from Hole No. 9 and Hole No. 18 to the club house 14. In fact, for still further reduction in features, if management were confident of the assigned starting times and could directly enter them into the computer 20 when the golfer checks in at the club house 14, it might be possible for the golfer to simply “report back in” at the terminal 114 upon the completion of the round to see if the calculated total time from the assigned starting time to the ending time is equal to or smaller than the predetermined desired play time.

From the discussions above, it should be clear that one skilled on the programming art will be able to develop a specific program for the computer 20 which would allow the system 110 to be modified to function with fewer and/or different components but with similar results.

In any case, as discussed above, the preferred system 10 and the alternative system 110 will be capable of being used for rounds of golf at the golf course that includes either nine holes or eighteen holes. However, despite the use of either system 10 or 110 and any number of the various modifications or alterations thereof, there are some situations in which the desired objective of insuring a rapid playing of the rounds by the various golfers are not always as successful as desired. For example, when the management selects a predetermined desired play time for the course, it is not uncommon for there to be shorter play times early in the morning which tends to require the establishment of an increase in the predetermined desired play time several times during the day. Invariably, the early golfers require less time to play a round and the general time required for playing tends increase as more golfers get on the course and the various groups begin to back up behind the those ahead. Despite the best of efforts by management, it is not uncommon for the “predicted” predetermined desired play time to be wrong and for there to be situations where too many golfers in too many groups are being “forced” to play slower than expected and to thus not receive an offer of a reward. With this situation occurring more often than desired, many of the golfers may grow to believe that the reward in not “worth” seeking. Accordingly, with all of the basic components included in the systems 10 or 110, there are alterations to the system programs that can be employed to provide another means for rewarding golfers for rapidly playing the rounds of golf.

It has been found that an alternative objective to generally insure that each golfer will play the round of golf as rapidly as possible is to encourage the golfers of one group to follow the preceding group of golfers as closely as possible. Accordingly, the system programs of the systems 10 and 110 can be altered to include an alternative way of receiving a reward. The basic components of the systems 10 and 110 are in place and only the programs need be altered or adapted in a manner which is well known to those skilled in the programming art to provide an alternative offering feature for the reward. In order for the golfer to be encouraged to closely follow the preceding golfer, the program must be configured to allow the starting time and ending time of each to be recognized and recorded for comparison. Heretofore, the basic programs for the systems 10 and 110 discussed above where primarily directed to each golfer individually without and reference to or dependence on the play of other golfers.

Accordingly, the alternative means for offering the reward includes establishing means within the system programs which will basically encourage the rapid completion of the round of golf by each golfer by insuring that the golfer will closely follow a preceding golfer on the course. The round of golf, whether for nine or eighteen holes, by each golfer includes sequentially playing each hole of the round while following the preceding golfer playing a similar round on the golf course. To provide a objective for which an alternative offer of a reward can be made, it is important to first establish a predetermined desired ending time differential between the completion of the round of golf by the preceding golfer and the golfer attempting to qualify for the offer of the reward. Within the system 10 or 110, there is included means for recognition of the appropriate identification means with a component near the last hole of the round, such as the terminal 34 or the reader 134 of the recognition means 113, for first recognizing the identification means of the preceding golfer at the end of the round of golf, after the completion of Hole No. 18, to record a first ending time. Additionally, the recognition means is used for recognizing the identification means of the golfer at the end of the round to record a second ending time. The system control circuit for system 10 or 110 would be programmed to determine an actual ending time differential for the round of golf by the golfer from the first ending time and the second ending time. Finally, the control circuit would be configured to include that alternative offering of the reward when the actual ending time differential is equal to or less than the predetermined desired round ending time differential.

It can be seen for this alternative offering of a reward for the golfer to be properly based of the rapid completion of the round following the completion of the round by the preceding golfer, the predetermined desired round ending time differential must be properly established. Within the system 10 or 110, this can be done by a number of alternative means.

In a first alternative means, the predetermine desired round ending time differential can be selectively established and changed by management according to the expected playing conditions at the course either before or during the round of golf. This might at first glance appear to be a difficult task for the management but, when one realizes the most golf course have a predefined starting time separation or differential that is often closely followed throughout the day, it is reasonable to expect that the management would simply use the same or a similar differential as the predetermined desired round ending time differential. It seems reasonable to “expect” the golfer to remain sufficiently close to the preceding golfer to be able to complete the round with a ending time differential behind that of the preceding golfer which is equal to or less than the differential at which the round began.

However, at some golf courses, the slow play that develops during the day sometimes also affects the starting time differential. In other words, for example, while a golfer might be scheduled to tee off at two in the afternoon, the starting time may be delayed until two-thirty to begin the round. Similarly, the next golfer may have been scheduled for two-ten but not be able to tee off until two-forty-two. Accordingly, while the “scheduled” starting time differential is ten minutes, the actual difference in the starting time would be twelve minutes. As a results, in a second alternative means for establishing the predetermined desired round ending time differential, in order to cause the predetermined desired round ending time differential to reflect such a situation and to not unduly “penalize” the golfers who are delayed at the first tee, the control means for the system 10 or 110 would include the recognition means, such as the terminal 30 or reader 130, which would be used to first recognize the first identification means of the preceding golfer at the beginning of the round of golf by the preceding golfer to record a first starting time. The recognition means would then recognize the second identification means of the golfer at the beginning of the round of golf by the golfer to record a second starting time. The control circuit is operably connected the recognition means to record the first and the second starting times and for calculating an actual starting time differential for the round of golf by the golfer from the first start time and the second start time. The predetermined desired round ending time differential would be established to be greater than the actual starting time.

Still further, in a third alternative means for establishing the predetermined desired round ending time differential, it is possible that the golf course management may wish to further modify the differential because of the continuing lengthening of both the starting time differential and the ending time differential throughout the day. Accordingly, the control circuit of the system 10 or 110 may further include a means for selectively establishing a predetermine delay time that will be added to the actual starting time differential to provide the predetermined desired round ending time differential. As a result, with the example mentioned above, a predetermined delay time of one minute might be selected for addition to the calculated actual starting time differential of twelve minutes to establish the predetermined desired round ending time differential at thirteen minutes. Such a modification is used to continue to present an achievable goal that will properly serve as an incentive to cause the golfer to rapidly complete the round after the completion by the preceding golfer and seek the alternative offering of the reward.

Those involved with the management of golf courses that offer nine hole and/or eighteen holes rounds of golf and those skilled in the programming art will be able the adapt the system 10 and/or the system 110 to use the recognition means incorporating the terminal 38 and/or reader 138 at Hole No. 9 and the terminal 42 and/or reader 142 at Hole No. 10. With a slightly more complicated but “user friendly” configuration, the system 10 and/or the system 110 will be able to allow various groups to take a break or to drop out of the course at Hole No. 9 and to finish the break or begin playing at Hole No. 10. With a proper system program, if a golfer is playing and that preceding golfer drops out of or leaves the course the system 10 and/or the system 110 will be able to recognized that there is a “new” preceding golfer and use the ending time thereof to calculate the actual ending time differential. Such a situation will thus continue to encourage the golfer to play faster and to reduce the separation time behind the “new” preceding golfer to allow all of the following golfers to relatively advance on the course prior to the completion of the round.

Additionally, those involved with the management of golf courses that expect groups of golfer to play a round of golf together and those skilled in the programming art will be able the adapt the system 10 and/or the system 110 to use the recognition means to establish a common starting time and common ending time for each golfer in the group and, similarly, for each preceding golfer in preceding group on the course. For example, the golfers and the preceding golfers can be instructed to all use the initial recognition means within a fixed period of time, such as two minutes, so that the system will assign a common starting time and a common ending time. For such a situation, the starting time “assigned” to each golfer of a group might be the starting time of the last golfer of the group with a similarly common “assignment” for each preceding golfer of the preceding group.

However, in order to reduce confusion and to insure fairness at the completion of the round of golf, the system may again assign the same ending time for each golfer of the group but may use the ending time of the first golfer of the entire group for calculating the actual ending time differential. On the other hand, the system may be instructed by the management and the system programmer to accept the last recognized ending time of the group for the establishing the ending time for the group which will be used in the calculation of the actual ending time differential for the next following group to determine if the next following group would qualify for the alternative offer of a reward. In other words each group at the completion of the round would be assigned two ending times, a first earlier ending time for the group itself and a second later time for the following group for use with the calculation of the actual ending time differential thereof.

It should be clear that the golfer using the complete system 10 or 110 may be offered a reward for the rapid playing of the round of golf if the total time for playing the round of golf is equal to or less than the predetermined desired play time and alternatively offered the reward for the rapid completion of the round of golf if the actual ending time differential is equal to or less than the predetermined desired round ending time differential. It should also be clear the there are sufficient components and features included in both the system 10 and the system 110 to enable one skilled the programming art to configure either or both of the systems 10 and 110 to provide the offer of a reward and/or the alternative offer of the reward in a manner which in within the scope of the invention as claimed.

It should also be apparent to those skilled in the computer programming art that many of the features and objects incorporated in the preferred system program as discussed hereinabove might be expanded or simplified in order to be able to practice the invention as taught herein. Clearly, any number of changes could be made to the system 10, the system 110 and any number of the alternative features and components thereof by those skilled in the art without departing from the scope of the invention as claimed.

What is claimed is:

1. A system for rewarding a golfer for rapidly playing of a round of golf that includes a predetermined number of golf holes at a golf course, the system comprising:
identification means for identifying the golfer;
recognition means located at a portion of the golf course near a first golf hole of the golf course and near a last golf hole of the golf course;
said recognition means for recognizing said identification means at the beginning of the round of golf by the golfer prior to the golfer approaching the first hole and for recognizing said identification means at the end of the round of golf by the golfer after the golfer leaves the last hole;
control means operably connected to said recognition means for recording a start time of the round of golf of the golfer when recognizing said identification means at the beginning of the round of golf and for recording an end time of the round of golf of the golfer when recognizing said identification means at the end of the round of golf;
said control means for determining a total time of play for the round of golf by the golfer from said start time and said end time;
said control means for comparing said total time with a predetermined desired play time for playing of the round of golf; and
said control means for offering a reward to the golfer when said total time is equal to or less than said predetermined desired play time.

2. The system for rewarding the golfer as set forth in claim 1, wherein said control means including means for selectively changing said predetermined desired play time by management of the golf course, whereby said predetermined desired play time is capable of being established by the management according to expected playing conditions at the golf course prior to the round of golf by the golfer.

3. The system for rewarding the golfer as set forth in claim 2, wherein said means for selectively changing said predetermined desired play time by the management can be used during the round of golf by the golfer to change said predetermined desired play time if there is a change of the expected playing conditions during the round of golf.

4. The system for rewarding the golfer as set forth in claim 1, wherein said control means includes means for selectively establishing said offering of said reward by the management of the golf course.

5. The system for rewarding the golfer as set forth in claim 1, wherein the golf course is one of a plurality golf courses in said system with each of said plurality of golf courses for separately rewarding a plurality of the golfers at said plurality of golf courses, further including a central data base, means for recording each round of golf and each said offering of said reward for each golfer in said central data base to establish a playing history of each golfer using any of the plurality of golf courses and means for selectively obtaining from said central data base said playing history for any one of the golfers by the management of each of the plurality of golf courses, whereby the management of each of the plurality of golf courses can use said playing history of any one of the golfers to select an appropriate starting time for any one of the golfers.

6. The system for rewarding the golfer as set forth in claim 5, further including means of using said central data base to selectively provide additional offerings of different rewards to selected ones of the golfers.

7. The system for rewarding the golfer as set for in claim 1, wherein the predetermined number of golf holes is nine holes, the first golf hole is hole number one, and the last golf hole is hole number nine.

8. The system for rewarding the golfer as set forth in claim 1, wherein the predetermined number of golf holes is eighteen holes, the first golf hole is hole number one, and the last golf hole is hole number eighteen.

9. The system for rewarding the golfer as set forth in claim 8, wherein the round of golf includes a golf round break between hole number nine and hole number ten, further including said recognition means located near hole number nine and hole number ten for recognizing said identification means at a beginning of the golf round break after the golfer plays hole nine to cause said control means to record a break start time and for recognizing said identification means at a completion of the golf round break prior to the golfer playing hole ten to cause said control means to record a break end time, and said control means for determining said total time of play from said start time and said end time includes means for subtracting a total break time established from said break start time and said break end time.

10. The system for rewarding the golfer as set forth in claim 1, wherein said identification means includes an identification card having readable strip means including unique information to identify the golfer; said control means includes course computer means having timing means, programming means, storage means and display means; said recognition means includes a terminal operably connected to said course computer means and said timing means thereof; and said terminal includes means for scanning said readable strip means of said identification card to collect said unique information for said course computer means and to establish said start time and said end time.

11. The system for rewarding the golfer as set forth in claim 10, wherein said terminal includes display means for displaying at least said offering of said reward for the golfer when said total time of play is less than said predetermined desired play time.

12. A system for rewarding a golfer for rapidly completing a round of golf that includes playing a predetermined number of golf holes at a golf course, the round of golf by the golfer including the sequential playing of each of the holes of the predetermined number of golf holes of the round of golf following a preceding golfer playing a similar round of golf that includes the predetermined number of golf holes to result in a completion of the round of golf by the golfer after a completion of the round of golf by the preceding golfer, the system comprising:
first identification means for identifying the preceding golfer;
second identification means for identifying the golfer;
recognition means located at a portion of the golf course at least near a last hole of the predetermined number of golf holes at the golf course;
said recognition means for recognizing said first identification means at the end of the round of golf by the preceding golfer after the preceding golfer leaves the last hole and for recognizing said second identification means at the end of the round of golf by the golfer after the golfer leaves the last hole;
control means operably connected to said recognition means for recording a first ending time of the round of golf of the preceding golfer when recognizing said first identification means at the end of the round of golf and for recording a second ending time of the round of golf of the golfer when recognizing said second identification means at the end of the round of golf;
said control means for determining an actual ending time differential for the round of golf by the golfer from said first ending time and said second ending time;
said control means for comparing said actual ending time differential with a predetermined desired round ending time differential after the end of the round of golf by the golfer following the end of the round of golf by the preceding golfer; and
said control means for offering a reward to the golfer when said actual ending time differential is equal to or less than said predetermined desired round ending time differential.

13. The system for rewarding the golfer as set forth in claim 12, wherein said recognition means is also located at a portion of the golf course near a first hole of the predetermined number of golf hole at the golf course, said recognition means is for recognizing said first identification means at the beginning of the round of golf by the preceding golfer prior to the preceding golfer approaching the first hole and for recognizing said second identification means at the beginning of the round of golf by the golfer prior to the golfer approaching the first hole, said control means is operably connected to said recognition means for recording a first starting time of the round of golf of the preceding golfer when recognizing said first identification means at the beginning of the round of golf and for recording a second starting time of the round of golf of the golfer when recognizing said second identification means at the beginning of the round of golf, said control means calculates an actual starting time differential for the round of golf by the golfer from said first start time and said second start time, and said predetermine desired round ending time is at least greater than said actual starting time differential.

14. The system for rewarding the golfer as set forth in claim 13, wherein said predetermined desired round ending time differential includes said actual starting time differential plus a predetermined delay time.

15. The system for rewarding the golfer as set forth in claim 14, wherein said control means includes means for selectively establishing said predetermined delay time by management of the golf course according to the expected playing conditions at the golf course.

16. The system for rewarding the golfer as set forth in claim 12, wherein said control means includes means for selectively changing said predetermined desired round ending time differential by management of the golf course, whereby said predetermined desired round ending time differential is capable of being established by the management according to expected playing conditions at the golf course prior to the round of golf by the golfer and said predetermined desired round ending time differential is capable of being changed by the management during the round of golf by the golfer if there is a change of the expected playing conditions during the round of golf.

17. The system for rewarding the golfer as set forth in claim 12, wherein said control means includes means for selectively establishing said offering of said reward by the management of the golf course.

18. The system for rewarding the golfer as set forth in claim 12, wherein said first identification means includes a first identification card having first readable strip means including first unique information to identify the preceding golfer, second identification means includes a second identification card having second readable strip means including second unique information to identify the preceding golfer, said control means includes course computer means having timing means, programming means, storage means and display means; said recognition means includes a terminal device operably connected to said course computer means and said timing means thereof; and said terminal device includes means for scanning said first and said second readable strip means respectively of said first and said second identification cards to collect said first and said second unique information for said course computer means and to establish said first ending time and said second ending time.

19. A method of rewarding a golfer for rapidly completing a round of golf that includes playing a predetermined number of golf holes at a golf course, the round of golf by the golfer including the sequential playing of each of the holes the predetermined number of golf holes of the round of golf following a preceding golfer playing a similar round of golf that includes the predetermined number of golf holes to result in a completion of the round of golf by the golfer after a completion of the round of golf by the preceding golfer, said method comprising the steps of:
establishing a predetermined desired round ending time differential for the completion of the round of golf by the golfer after the completion of the round of golf by the preceding golfer;
providing a first readable device for identifying the preceding golfer;
providing a second readable device for identifying the golfer;
reading said first readable device on the golf course at the end of the round of golf by the preceding golfer;
recording a first ending time of the round of golf during said reading of said first readable device;
reading said second readable device on the golf course at the end of the round of golf by the golfer;
recording a second ending time of the round of golf during said reading of said second readable device;
calculating an actual ending time differential for the round of golf by the golfer from said first ending time and said second ending time
comparing said predetermined desired round ending time differential with said actual ending time differential; and
offering a reward to the golfer when said actual ending time differential is equal to or less than said predetermined desired round ending time differential.

20. The method of rewarding a golfer as set forth in claim 19, wherein said step of said establishing said predetermined desired round ending time differential for the completion of the round of golf by the golfer after the completion of the round of golf by the preceding golfer initially includes the steps of:
initially reading said first readable device on the golf course at the beginning of the round of golf by the preceding golfer;
initially recording a first starting time of the round of golf by the preceding golfer during said initial reading of said first readable device;
initially reading said second readable device on the golf course at the beginning of the round of golf by the golfer;
initially recording a second starting time of the round of golf by the golfer during said initial reading of said second readable device;
calculating an actual starting time differential for the round of golf by the golfer from said first starting time and said second starting time; and
said establishing said predetermined desired round ending time differential for the completion of the round of golf by the golfer includes causing said predetermined desired round ending time differential to be at least greater than said actual starting time differential.

21. The method of rewarding the golfer as set forth in claim 20, wherein said step of causing said predetermined desired round ending time differential to be at least greater than said actual starting time differential includes the step of adding a predetermined acceptable delay time to said actual starting time differential to produce said predetermined desired round ending time differential.

22. The method of rewarding the golfer as set forth in claim 19, wherein said step of said establishing said predetermined desired round ending time differential for the completion of the round of golf by the golfer is accomplished by management of the golf course according to expected playing conditions at the golf course prior to the round of golf by the golfer.

23. The method of rewarding the golfer as set forth in claim 22, wherein said establishing said predetermined desired round ending time differential for the completion of the round of golf by the golfer includes selectively changing said predetermined desired round ending time differential for the completion of the round of golf by the golfer by the management during the round of golf by the golfer if there is a change of the expected playing conditions during the round of golf by the golfer.

24. The method of rewarding the golfer as set forth in claim 19, wherein said offering said reward includes selectively establishing said reward by the management of the golf course.
